(19) United States
(12) Patent Application Publication
(10) Pub. No.: US 2008/0091473 A1
(43) Pub. Date: Apr. 17, 2008

(54) WORKFLOW NOTIFICATION SYSTEM FOR MEDICAL IMAGING APPARATUS, MEDICAL IMAGING APPARATUS, WORKFLOW NOTIFICATION METHOD FOR MEDICAL IMAGING APPARATUS, AND WORKFLOW NOTIFICATION PROGRAM FOR MEDICAL IMAGING APPARATUS

(76) Inventor: Antoine Choppin, Tokyo (JP)

Correspondence Address: Patrick W. Rasche;Armstrong Teasdale LLP, Suite 2600, One Metropolitan Square, St. Louis, MO, 63102, US

(21) Appl. No.: 11/872,592

(22) Filed: Oct. 15, 2007

(30) Foreign Application Priority Data
Oct. 17, 2006 (JP) 2006-282722

(51) Int. Cl. G06Q 50/00

(52) U.S. Cl. 705/3

(57) ABSTRACT

According to the attributes of notification targets such as patients, radiology doctors, and nurses, information owned by medical imaging apparatuses is provided in appropriate timing to improve a workflow of hospitals. A dispatch agent being a software component is executed on a processor of a medical imaging apparatus. Different types of observer terminals (cellular phones, etc.) in which observer agents conforming to the attributes of notification targets operate register information (event) desired for notification in the dispatch agent. The dispatch agent monitors various processing processes being executed in the processor, and on detecting the occurrence of a registered event, notifies the observer terminals of its occurrence. Since the dispatch agent is also a sort of processes executed in the processor, network traffic is not increased by its monitoring of various processing processes.

According to the attributes of notification targets such as patients, radiology doctors, and nurses, information owned by medical imaging apparatuses is provided in appropriate timing to improve a workflow of hospitals. A dispatch agent being a software component is executed on a processor of a medical imaging apparatus. Different types of observer terminals (cellular phones, etc.) in which observer agents conforming to the attributes of notification targets operate register information (event) desired for notification in the dispatch agent. The dispatch agent monitors various processing processes being executed in the processor, and on detecting the occurrence of a registered event, notifies the observer terminals of its occurrence. Since the dispatch agent is also a sort of processes executed in the processor, network traffic is not increased by its monitoring of various processing processes.

### BACKGROUND OF THE INVENTION

The present invention relates to a workflow notification system for a medical imaging apparatus, a medical imaging apparatus, a workflow notification method for a medical imaging apparatus, and a workflow notification program for a medical imaging apparatus. Specifically, the present invention relates to a workflow notification system for a medical imaging apparatus, a medical imaging apparatus, a workflow notification method for a medical imaging apparatus, and a workflow notification program for a medical imaging apparatus that notify persons needing the following information of required and adequate amounts of the information in appropriate timing according to the attributes of the persons. The information is imaging information of a medical imaging apparatus in the medical field such as MRI apparatuses, CT scanners, and ultrasonic diagnostic equipment.

In hospitals, a hospital information system (HIS) and a radiology information system (RIS) are operated. The HIS is a system that uses computers to perform the management of patients' reception and personal information (name, age, address, hospital visiting history, and treatment condition) and the accounting of consultation fees, and the RIS is a system that consistently performs the reservation of radiographic inspection, inspection reception, the reading and storage of inspection data, and medical demand, in conjunction with the HIS.

In hospitals, different types of medical imaging apparatuses (modality) such as MRI apparatuses, CT scanners, and ultrasonic diagnostic equipment are used. To enable these medical imaging apparatuses to be mutually connected through a network and image storage media to exchange patients' image inspection information and transmit image data, DICOM (Digital Imaging and COmmunications in Medicine) is established as standards regarding medical digital images and communications. Medical imaging apparatuses read inspection order information such as a patient name and an inspection type from the HIS/RIS according to DICOM MWM (Modality Worklist Management), and send an inspection progress state and information about inspections already terminated to the HIS/RIS according to DICOM MPPS (Modality Performed Procedure Step) (see paragraphs [0002] to [0012] of patent document 1, for example).

[Patent Document 1] Japanese Unexamined Patent Publication No. 2005-261952.

Although imaging progress states such as in-progress, complete, stop, and postpone, and information about inspections already terminated are sent from medical imaging apparatuses to the HIS/RIS, real-time information such as estimated remaining time of inspection, the number of images produced, and an estimated number of images to be produced are not offered.

Since notification of inspection information and the like is made to nurses over telephones and pagers (pocket beepers), inspection engineers to make notification are burdened.

### SUMMARY OF THE INVENTION

It is desirable that problems described previously are solved.

In one aspect of the invention, a workflow notification system for a medical imaging apparatus is a system including a medical imaging apparatus connected to a network, and plural observer terminals, wherein a processor included in the medical imaging apparatus executes plural processing processes, and the plural processing processes generate events unique to the processing processes. The observer terminals transmit a registration request for a specified one of the events to the medical imaging apparatus via the network. The medical imaging apparatus accepts the registration request transmitted from the observer terminals via the network, monitors the processing processes being executed in the processor, and when detecting the occurrence of the registered event, transmits a notification message to the observer terminals via the network. The observer terminals receive the notification message from the medical imaging apparatus.

Preferably, in the workflow notification system for a medical imaging apparatus, when the event does not occur after transmitting the notification message, the medical imaging apparatus transmits an end message to the observer terminals, or when the event further occurs subsequently, continues to monitor the processing processes being executed in the processor, and when detecting the occurrence of the registered event, again transmits the notification message to the observer terminals via the network. The observer terminals receive the end message or the notification message from the medical imaging apparatus.

Preferably, in the workflow notification system for a medical imaging apparatus, when receiving the registration request for the event transmitted from the observer terminals, the medical imaging apparatus determines whether the event is approved for notification in a class to which the observer terminals belong, when the event is approved for notification, checks the processing processes being executed in the processor to determine whether the event already occurs, and when the event already occurs, transmits a notification message to the observer terminals via the network, or when the event does not occur yet, transmits an acceptance message to the observer terminals. The observer terminals receive the notification message or the acceptance message from the medical imaging apparatus.

Preferably, in the workflow notification system for a medical imaging apparatus, at least two medical imaging apparatuses connected to a network and an authenticating server are included. The observer terminals transmit an authentication request targeted for a specified medical imaging apparatus to the authenticating server. When receiving the authentication request, the authenticating server determines whether the observer terminals are ones to be authenticated, when they are observer terminals to be authenticated, transmits a first authentication approval message to the observer terminals that transmit the authentication request. When receiving the first authentication approval message, the observer terminals that transmit the authentication request become able to transmit the registration request to the specified medical imaging apparatus. When the observer terminals that transmit the authentication request are ones to be authenticated, the authentication server further determines a class to which the observer terminals belong, and transmits a second authentication approval message and the class to the specified medical imaging apparatus targeted for the authentication request. When receiving the authentication approval message and the class, the specified medical imaging apparatus targeted for the authentication request becomes able to accept the registration request from the observer terminals that transmit the authentication request.

Preferably, in the workflow notification system for a medical imaging apparatus, the observer terminals include a reception observer terminal in which the telephone number of a pager is registered, and on receiving the notification message from the medical imaging apparatus, the reception observer terminal makes a call to the registered telephone number of the pager.

In another aspect of the invention, a medical imaging apparatus are connected to a network and includes a processor, the processor executes plural processing processes, and the plural processing processes generate events unique to the processing processes. The medical imaging apparatus comprises: a registering part that accepts a registration request for a specified event from an observer terminal, via the network; a monitoring part that monitors the processing processes being executed in the processor to detect the occurrence of the registered event; and a notification part that, when the occurrence of the registered event is detected by the monitoring part, transmits a notification message to the observer terminal via the network.

Preferably, in the medical imaging apparatus, when the event does not occur after transmitting the notification message, the notification part transmits an end message to the observer terminal, or when the event further occurs subsequently, proceeds to the monitoring part. The monitoring part continues to monitor the processing processes being executed in the processor, and when detecting the occurrence of the registered event, again transmits the notification message to the observer terminal via the network.

Preferably, in the medical imaging apparatus, on receiving the registration request for the specified event transmitted from the observer terminal, the registering part determines whether the event is approved for notification in a class to which the observer terminal belongs, when the event is approved for notification, checks the processing processes being executed in the processor to determine whether the event already occurs, and when the event already occurs, transmits a notification message to the observer terminal via the network, or when the event does not occur yet, transmits an acceptance message to the observer terminal.

Preferably, the medical imaging apparatus includes an authenticating and classifying part that, on receiving an authentication request from the observer terminal, determines whether the observer terminal is one to be authenticated, when the observer terminal is one to be authenticated, transmits a first authentication approval message to the observer terminal that transmits the authentication request, and determines a class to which the observer terminal that transmits the authentication request belongs.

According to the invention, according to the attributes of notification targets such as patients, radiology doctors, and nurses, information owned by medical imaging apparatuses such as patients' estimated wait time, information about inspections already terminated, and inspection start time of a next patient can be provided in appropriate timing, thereby saving useless wait time and work and improving a workflow of hospitals.

Further objects and advantages of the present invention will be apparent from the following description of the preferred embodiments of the invention as illustrated in the accompanying drawings.

### BRIEF DESCRIPTION OF THE DRAWINGS

FIG. 1 is a drawing showing an example of a workflow notification system for a medical imaging apparatus of a first embodiment of the invention.

FIG. 2 is a drawing showing the construction of an MRI apparatus 20 as an example of a medical imaging apparatus.

FIG. 3 is a drawing showing an example of a detailed construction of an operator console 27 of an MRI apparatus.

FIG. 4 is a block diagram showing processing of a dispatch agent.

FIG. 5 is a drawing showing a processing flow of a dispatch agent.

FIG. 6 is a drawing showing a processing flow of an observer agent.

FIG. 7 is a drawing showing a relationship between the workflow notification system for a medical imaging apparatus in FIG. 1 and a telephone network 80.

FIG. 8 is a drawing showing an example of a workflow notification system for a medical imaging apparatus as another embodiment of the invention.

FIG. 9 is a block diagram showing processing of a dispatch agent in an embodiment of FIG. 8.

### DETAILED DESCRIPTION OF THE INVENTION

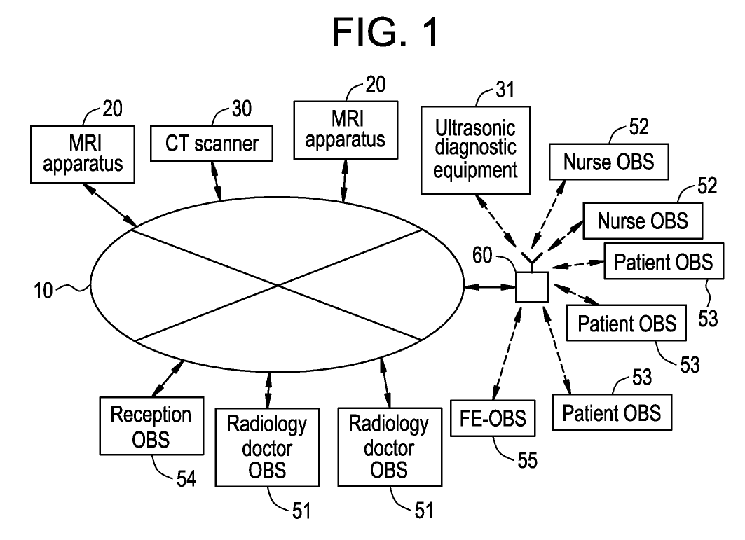

FIG. 1 is a drawing showing an example of a workflow notification system for a medical imaging apparatus of a first embodiment of the invention. The system comprises medical imaging apparatuses such as MRI apparatuses 20 and a CT scanner 30, and observer terminals such as observer terminals 51 for radiology doctor and an observer terminal 54 for reception that are connected by cables to a network 10, and a medical imaging apparatus such as ultrasonic diagnostic equipment 31, and observer terminals such as observer terminals 52 for nurse, observer terminals 53 for patient, and an observer terminal 55 for field engineer that are wirelessly connected via a wireless LAN base station 60.

Medical imaging apparatuses such as the MRI apparatus 20, the CT scanner 30, and the ultrasonic diagnostic equipment 31 include a processor, and a dispatch agent being a software component is executed on the processor. The dispatch agent informs various observer terminals of information requested by the observer terminals in appropriate timing. Medical imaging apparatuses to which the invention is applied may be other than the MRI apparatus 20, the CT scanner 30, and the ultrasonic diagnostic equipment 31 if they are connected to a network and include a processor.

When an observer agent being a software component is started in terminals such as personal computers, cellular phones, and PDAs that are connected to a network, these terminals function as observer terminals. The observer terminals register information to be acquired in the dispatch agent. When registered information occurs when processors of the medical imaging apparatuses are executing different types of processing processes, the observer terminals receive notification that the information has occurred, from the dispatch agent via the network.

Observer terminals may be other than personal computers, cellular phones, and PDAs if they are connected to a network and can execute an observer agent. Two or more observer agents may be executed at the same time on one personal computer. Examples are concurrent execution of an observer agent for radiology doctor and an observer agent for nurse, or concurrent execution of plural observer agents for reception on one personal computer. Two or more observer agents may be executed at the same time on cellular phones and PDAs as well. For example, when an observer agent for radiology doctor and an observer agent for nurse are executed at the same time on one personal computer, it is determined that an observer terminal for radiology doctor and an observer terminal for nurse exist at the same time.

Networks include the Internet besides intranets within a hospital. Therefore, observer terminals can receive notification from dispatch agents even outside the hospital.

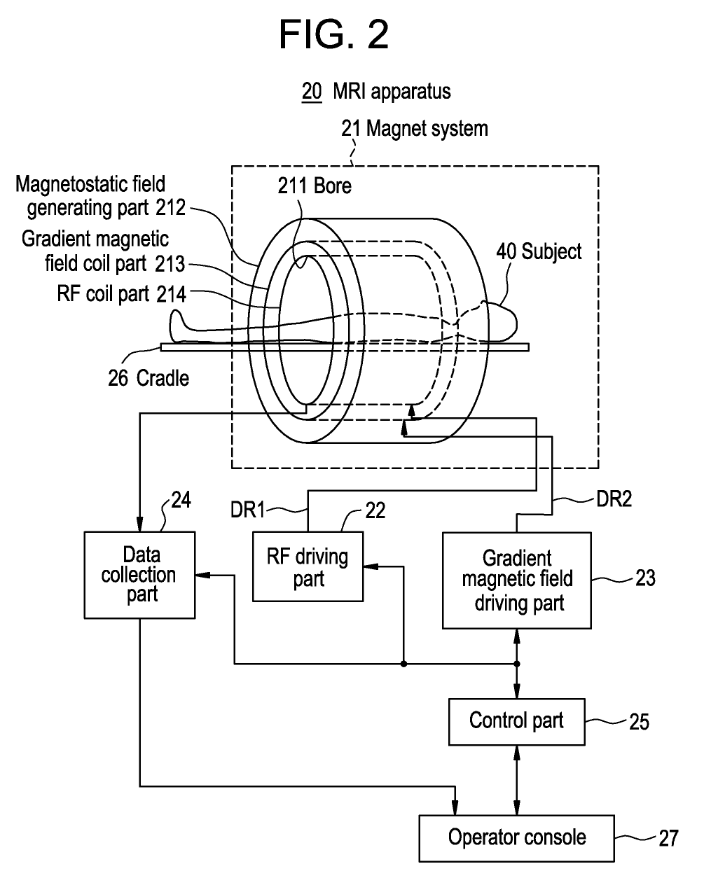

FIG. 2 is a drawing showing the construction of an MRI apparatus 20 as an example of a medical imaging apparatus. The MRI apparatus 20 includes a magnet system 21, an RF driving part 22, a gradient magnetic field driving part 23, a data collection part 24, a control part 25, a cradle 26, and an operator console 27.

The magnet system 21 includes an approximately columnar internal space (bore) 211 as shown in FIG. 2. Within the bore 211, the cradle 26 on which a subject 40 is mounted through a cushion is conveyed by a conveying part (not shown).

In the magnet system 21, on the periphery of a magnet sensor (central position of scanning), a magnetostatic field generating part 212, a gradient magnetic field coil part 213, and an RF coil part 214 are disposed. The magnetostatic field generating part 212 forms a magnetostatic field in the bore 211. The direction of the magnetostatic field is parallel to the body axis of the subject 40. The gradient magnetic field coil part 213, to provide a magnetic resonance signal received by the RF coil part 214 with three-dimensional position information, generates a gradient magnetic field to give a gradient to the strength of a magnetostatic field formed by the magnetostatic field generation part 212. The coil part 214 forms a high frequency magnetic field to excite a spin in the body of the subject 40 in the magnetostatic field space formed by the magnetostatic field generating part 212. The RF coil part 214 receives an electromagnetic wave generated by the spin excited in the body of the subject 40 as a magnetic resonance signal.

The RF driving part 22 feeds a driving signal DR1 to the RF coil part 214 according to a command of the control part 25 to generate a high frequency magnetic field, and excites a spin in the body of the subject 40. The gradient magnetic field driving part 23 feeds a driving signal DR2 to the gradient magnetic field coil part 213 according to a command of the control part 25 to generate a gradient magnetic field. The data collection part 24 captures a magnetic resonance signal received by the RF coil part 214, performs A/D conversion and the like, and outputs the result to the operator console 27.

The control part 25 controls the RF driving part 22 and the gradient magnetic field driving part 23 to feed the driving signals DR1 and DR2 according to a predetermined pulse sequence in line with the protocol to carry out, sent from the operator console 27. Furthermore, the control part 25 controls the data collection part 24.

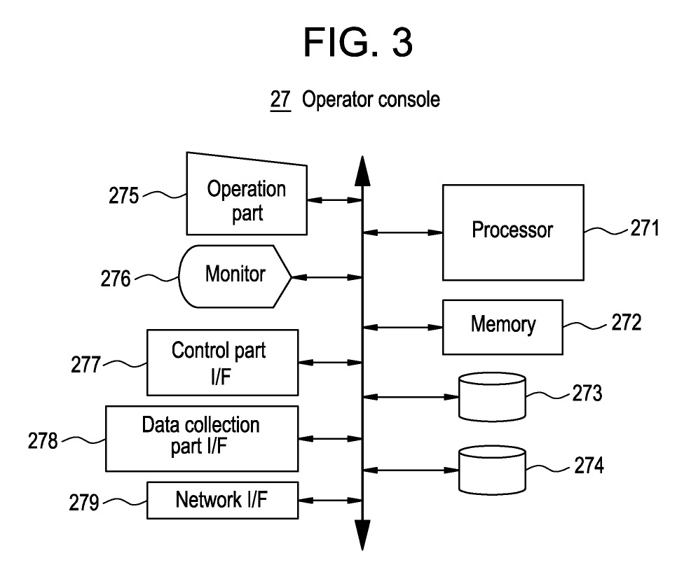

FIG. 3 is a drawing showing an example of a detailed construction of the operator console 27 of the MRI apparatus. The operator console 27 includes a processor 271, a memory 272, an image processing database 273, an image database 274, an operation part 275, a monitor 276, a control part interface 277, a data collection part interface 278, and a network interface 279.

The processor 271 executes dispatch agents. It sends a protocol to carry out that corresponds to a specimen part of the subject 40, to the control part 25 from the control part interface 277. Furthermore, the processor 271 performs image reconstruction processing, based on a magnetic resonance signal received in the RF coil part 214.

The image processing database 273 and the image database 274 are composed of a recordable/reproducible disk drive and the like. The image processing database 273 stores dispatch agent programs, image processing application programs, image processing protocol data, and the like. The image database 274 stores data and reconstruction image data collected in the data collection part 24. The image processing database 273 and the image database 274 may be composed of a common disk drive or the like.

The operating part 275 is composed of a keyboard, a mouse, and the like. The monitor 276 is composed of a graphic display and the like.

The control part interface 277 is connected with the control part 25, and sends to the control part 25 a protocol to be executed. The data collection part interface 278 is connected with the data collection part 24, and receives a digitalized magnetic resonance signal from the data collection part 24.

The network interface 279 is connected to the network 10, and transmits and receives communication data between a dispatch agent and an observer agent. It also transmits and receives communication data between HIS/RIS and various servers.

A dispatch agent executed in the processor 271 monitors other processing processes, and grasps all operations performed in medical imaging apparatuses such as an MRI apparatus and planned scans. For example, information grasped by a dispatch agent of the MRI apparatus is (1) estimation of scan total time for each patient, (2) operating states of the MRI apparatus such as positioning, prescan, scan, and idle, (3) information about patient being scanned or already scanned, (4) number of reconstructed images, (5) number of images reviewed for checking image quality, (6) number of images transmitted over a network, (7) number of printed images, (8) number of images subjected to post-processing, and (9) logged error messages and warnings.

Observer terminals belong to one or plural classes. The classes include radiology doctor class, other-division doctor class, nurse class, patient class, reception class, accounting class, and field engineer class. The observer terminals 51 for radiology doctor, observer terminals for other-division doctor, the observer terminals 52 for nurse, the observer terminals 53 for patient, the observer terminal 54 for reception, an observer terminal for accounting, and observer terminals 55 for field engineer are observer terminals belonging to radiology doctor class, other-division doctor class, nurse class, patient class, reception class, accounting class, and field engineer class, respectively.

Information that each of the observer terminals can receive from the dispatch agent depends on the classes. For example, observer terminals of the radiology doctor class can receive all information of all patients. Observer terminals of the patient class cannot receive information of other patients but can obtain estimated wait time calculated by the dispatch agent. Specifically, information that the observer terminals can receive from the dispatch agent differs depending on the classes to which the observer terminals belong. Therefore, for example, one patient's acquiring information about the conditions of other patients can be prevented, contributing to the protection of the privacy of patients.

The specifications, claims, and drawings refer to information registered for notification in the dispatch agent by the observer terminals as an event. The dispatch agent notifies the observer terminals of the occurrence of an event when it occurs. Examples of events are “10 minutes before starting to image patient A”, “Scanning is started”, “Scanning is terminated”, “Abdomen restructure image is completed”, and “Five minutes before the end of imaging patient B”. Events not limited in notification in a belonging class are referred to as events approved for notification, and events limited in notification in a belonging class are referred to as events not approved for notification.

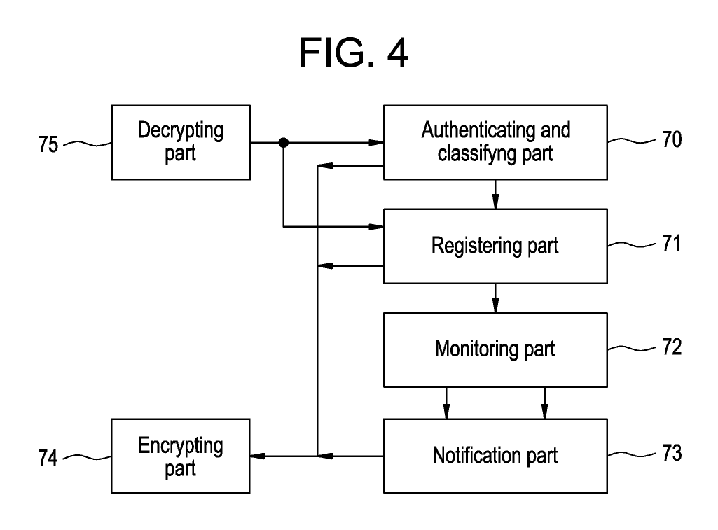

FIG. 4 is a block diagram showing processing of a dispatch agent. The dispatch agent comprises six blocks, that is, an authenticating and classifying part 70, a registering part 71, a monitoring part 72, a notification part 73, an encrypting part 74, and a decrypting part 75.

The authenticating and classifying part 70 determines whether an observer terminal to request authentication is an observer terminal to be authenticated, and when it is an observer terminal to be authenticated, further determines a class to which the observer terminal belongs. The authenticating and classifying part 70 first receives an authentication request including an ID and password from an observer agent. Next, it performs authentication by the ID and the password, and make a classification by the ID. Then, it transmits an authentication message to the observer agent. The content of the authentication message is approval or refusal.

The registering part 71 accepts the registration of an event from an observer terminal. It first receives a registration request for a specific event from the observer terminal. Next, it determines whether the event is approved for notification in the class of the observer terminal. When the event is not approved for notification, the registering part 71 transmits an error message to the observer terminal. The content of the error message is “The event is not approved for registration in XX class.” or the like. When the event is approved for notification, the registering part 71 checks processing processes being executed in the processor to determine whether the event already occurs. When the event already occurs, the dispatch agent transfers control from the registering part 71 to the notification part 73. When the event does not occur yet, the registering part 71 sends an acceptance message to the observer terminal.

The monitoring part 72 monitors processing processes being executed in the processor to detect the occurrence of an event. The dispatch agent is a sort of process executed in the processor. Therefore, the monitoring part 72 is executed confinedly within the processor. If the monitoring part 72 is assumed to operate in a monitoring server other than medical imaging apparatuses, even when no event occurs, the monitoring server must inquire of the medical imaging apparatuses as to the occurrence of events, and in reply to it, the medical imaging apparatuses must indicate that no events occur. For the purpose of the inquiry and reply, processors in the medical imaging apparatuses must execute a communication process, increasing processing loads on the processors. Furthermore, communications for indicating that no event occurs frequently occur between the monitoring server and the medical imaging apparatuses, and traffics of the network 10 increase. However, according to this embodiment, communication occurs on the network 10 only when an event occurs, and when no event occurs, the processors in the medical imaging apparatuses perform only processing confined within the processors. Therefore, there is no significant increase in processing loads on the processors, and traffics of the network 10 do not increase.

The notification part 73 notifies observer terminals that an event occurs. When it is determined by the registering part 71 that the event already occurs, and when the occurrence of an event is detected by the monitoring part 72, the notification part 78 transmits a notification message to the observer terminals. When an event occurs subsequently, the dispatch agent transfers control from the notification part 73 to the monitoring part 72 to continue to monitor processing processes. When no event occurs subsequently, the notification part 73 transmits an end message to the observer terminals. An example of subsequent occurrence of an event is that when an event registered is “a series being imaged and the number of reconstructed images are obtained in real time”, the series still continues. In this case, each time the monitoring part 72 detects the occurrence of an event that “a new image is reconstructed”, the notification part 73 transmits a notification message to the observer terminals.

The encrypting part 74 encrypts messages. It encrypts an authentication message, an error message, an acceptance message, a notification message, and an end message received from the authenticating and classifying part 70, the registering part 71, and the notification part 73 to transmit them to observer terminals. The decryption part 75 decrypts encrypted requests. It decrypts an encrypted authentication request and registration request received from observer terminals to then pass them to the authenticating and classifying part 70 and the registering part 71.

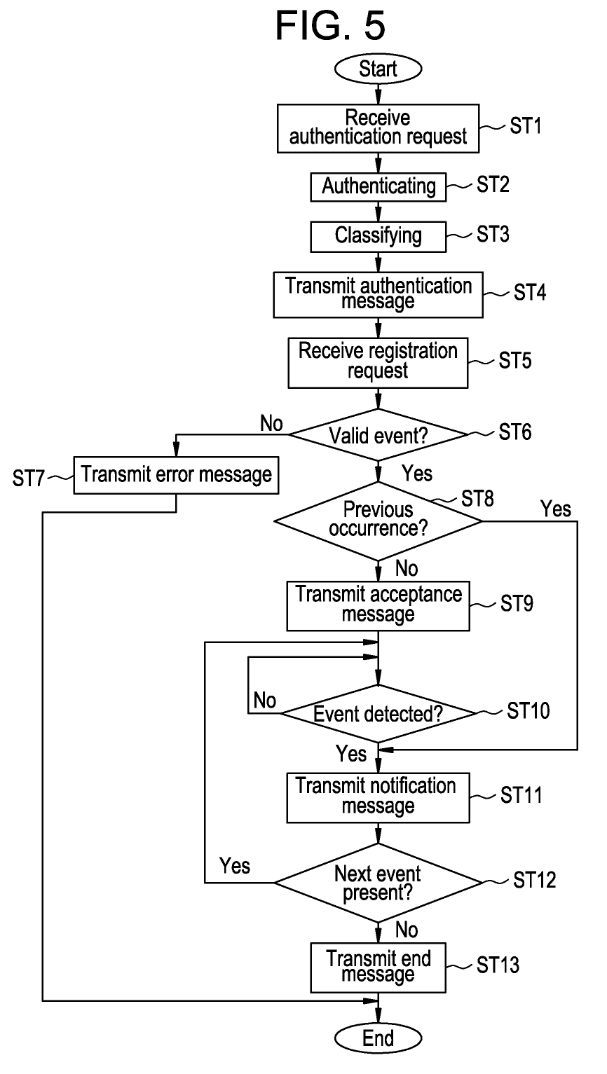

FIG. 5 is a drawing showing a processing flow of the dispatch agent. Processing of the dispatch agent is as follows.

Authenticating and classifying process: The dispatch agent receives an authentication request including ID and password from an observer agent (Step ST1). The dispatch agent decrypts the encrypted authentication request, performs authentication based on the ID and password (Step ST2), and makes a classification by the ID (Step ST3). The dispatch agent transmits an authentication message to the observer agent (Step ST4).

Registering process: The dispatch agent receives a registration request of an event from the observer agent (Step ST5). The dispatch agent decrypts the encrypted registration request, and determines whether the registration request is a registration request of an event approved for notification in the class to which the observer terminal belongs (Step ST6). When it is a registration request of an event not approved for notification, the dispatch agent transmits an error message to the observer agent (Step ST7). When it is a registration request of an event approved for notification, the dispatch agent checks processing processes being executed in the processor, and determines whether the event of the registration request already occurs (Step ST8). When it is an event that already occurs, the dispatch agent moves to Step ST 11 of a notification process described later. When it is an event that does not occur yet, the dispatch agent transmits an encrypted acceptance message to the observer agent (Step ST9).

Monitoring process: The dispatch agent monitors the processing process being executed in the processor to detect an event (Step ST 10).

Notification process: On detecting an event, the dispatch agent transmits an encrypted notification message to the observer agent (Step ST 11). When an event occurs subsequently, the dispatch agent returns to Step ST10 (Step ST12), and when no event occurs subsequently, it transmits an encrypted end message to the observer agent (Step ST13).

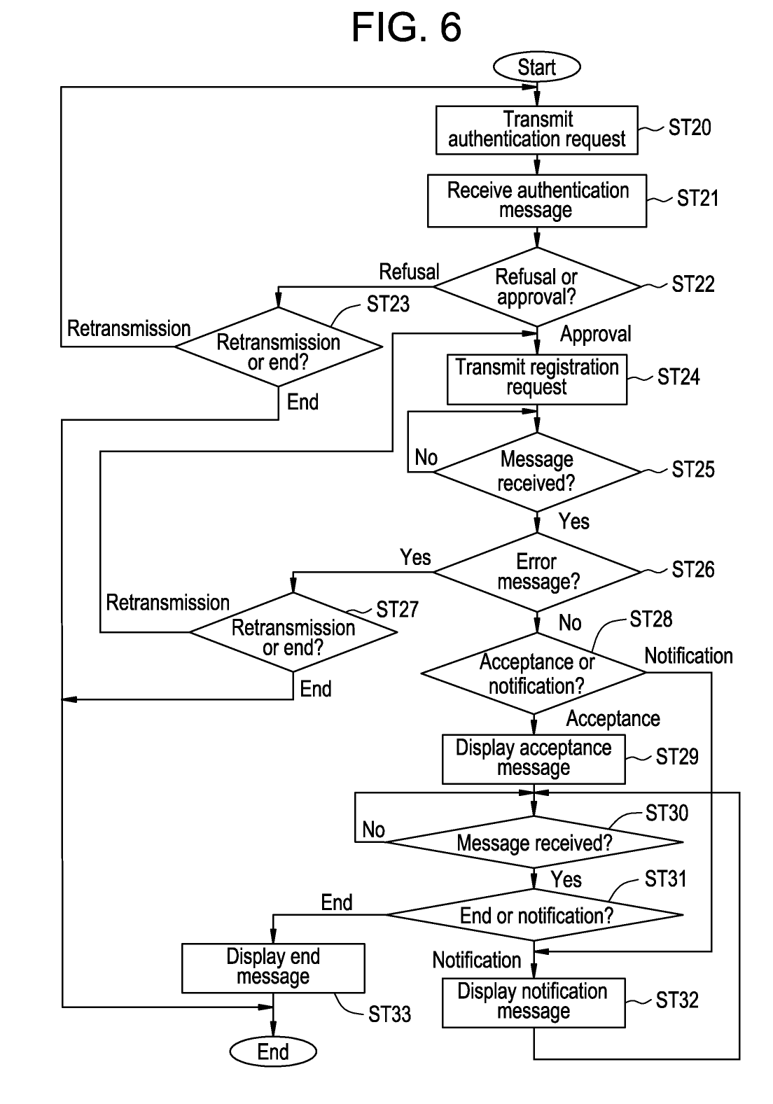

FIG. 6 is a drawing showing a processing flow of an observer agent. Processing of the observer agent is as follows.

Authenticating process: The observer agent encrypts an authentication request including ID and password and transmits the encrypted request to the dispatch agent (Step ST20). The observer agent receives an encrypted authentication message from the dispatch agent (Step ST21). The observer agent decrypts the authentication message and determines its content (Step ST22). When it is refusal, the observer agent prompts the user to select between the retransmission of an authentication request including a correct ID and password and an end (Step ST23).

Registering process: When the content of the authentication message is approval, the observer agent encrypts a registration request of a specific event and transmits the encrypted request to the dispatch agent (Step ST24). The observer agent waits to receive a message returned from the dispatch agent (Step ST25). The observer agent determines whether the received message is an error message (Step ST26), and when it is an error message, prompts the user to select between the retransmission of a correct registration request and an end (Step ST27). When the received message is not an error message, the observer agent determines whether it is an acceptance message or notification message (Step ST28), and when it is an acceptance message, the observer agent displays the content of the acceptance message on the screen (Step ST29). When it is a notification message, the observer agent moves to Step ST32 described later to display the content of the notification message on the screen (Step ST32).

Monitoring process: The observer agent waits for a notification message or an end message from the dispatch agent (Step ST30).

Notification process: The observer agent decrypts the message received from the dispatch agent, and determines whether it is a notification message or an end message (Step ST31). When the received message is a notification message, the observer agent displays the content of the notification message on the screen and returns to Step ST30 (Step ST32). When the received message is an end message, the observer agent displays the content of the end message on the screen, and ends (Step ST33).

The notification message is displayed on the screen of the observer terminal, along with a warning signal such as a buzzer, vibration, lamp blinking, and icon blinking.

The acceptance message, the notification message, and the end message need to be not necessarily wholly composed of text data. When the messages are composed of typical text, it goes without saying that a text number assigned to the typical text may be transmitted for conversion into text data in observer terminals. Although, in the above description, communication between observer agents and dispatch agents is encrypted, messages may be transmitted in plain text without being encrypted, depending on their contents.

The following shows an embodiment of a workflow notification system for a medical imaging apparatus according to the invention.

When a nurse wants to know when to go to meet a patient A having been imaged, he (she) activates an observer agent of cellular phones to transmit a registration request of an event “Three minutes before the imaging of patient A is terminated” to dispatch agents. On accepting the registration, the dispatch agents of the MRI apparatuses 20 return an acceptance message. When the imaging of the patient A nears an end and the event “Three minutes before the imaging of patient A is terminated” occurs, the dispatch agents transmit a notification message “Three minutes before the imaging of patient A is terminated” to the observer terminals 52 (cellular phone) for nurse. The nurse knows from the notification message that the imaging of the patient A will be soon terminated, and goes to meet the patient A.

For emergent MR inspection, as soon as an image has been acquired, a radiology doctor must make a diagnosis based on the image. Accordingly, he (she) activates an observer agent of radiology doctor console to transmit a registration request of an event “A series being imaged and the number of reconstructed images are acquired in real time”. On accepting the registration, a dispatch agent of the MRI apparatus 20 immediately returns a notification message “A series being imaged and the number of reconstructed images” at that point. Subsequently, each time an event that an image is reconstructed occurs, the dispatch agent of the MRI apparatus 20 transmits a notification message “A series being imaged and the number of reconstructed images”. Since the notification message arrives in the observer terminal 51 (radiology doctor console) for radiology doctor, the radiology doctor can know a series being imaged and the number of reconstructed images in a consulting room in which the radiology doctor console is installed, and can observe the progress of inspection in real time. When an important image is reconstructed, the radiology doctor transfers the reconstructed image from the MRI apparatus 20 for a diagnosis.

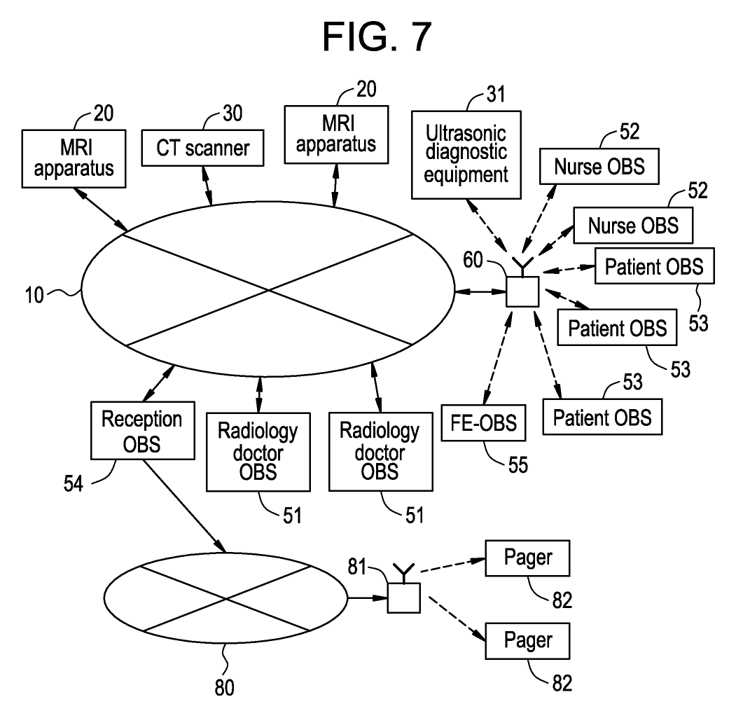

FIG. 7 is a drawing showing a relationship between the workflow notification system for a medical imaging apparatus in FIG. 1 and a telephone network 80. In FIG. 7, the telephone network 80, a pager base station 81, and pagers 82 are added to the workflow notification system for a medical imaging apparatus in FIG. 1. A person in charge of reception, to know waiting time for inspection by the MRI apparatuses 20, registers a patient identification code and a telephone number of a pager, and activates an observer agent of a reception terminal to transmit a registration request of an event “Five minutes before the end of imaging on a preceding patient” to a dispatch agent. The registration request includes the patient identification code for identifying the patient. The patient identification code, unlike an ID for identifying an observer terminal, is assigned to each of patients. A pager 82 corresponding to the patient identification code is passed to the patient. When an event that estimated remaining scan time of a preceding patient is five minutes occurs, the dispatch agent of the MRI apparatus 20 transmits a notification message “Five minutes before the end of imaging on a preceding patient” to the observer terminal 54 (reception terminal) for reception. The notification message includes the patient identification code of the next patient to be imaged. On receiving the notification message, the observer terminal 54 for reception displays the content of the notification message on its screen, and at the same time automatically makes a call to the telephone number of a pager 82 corresponding to the patient identification code. Since the pager 82 rings a bell, the patient knows that inspection start time of the MRI apparatus 20 is approaching.

Without a patient identification code being included in a registration request and a notification message, an observer agent of an ID different for each patient may be activated on a reception terminal.

To know time when the MRI apparatus 20 can be checked, a field engineer activates an observer agent of a cellular phone to transmit a registration request of an event “Completion of imaging” to a dispatch agent. On accepting the registration, the dispatch agent of the MRI apparatus 20 returns a notification message “It will take XX hours and YY minutes to complete imaging” to an observer terminal (cellular phone) 55 for field engineer. When an event that imaging is completed occurs, the dispatch agent transmits a notification message “Imaging is completed”. By receiving the notification message in the observer terminal 55 for field engineer, the field engineer knows that imaging is completed, and starts to check the MRI apparatus 20.

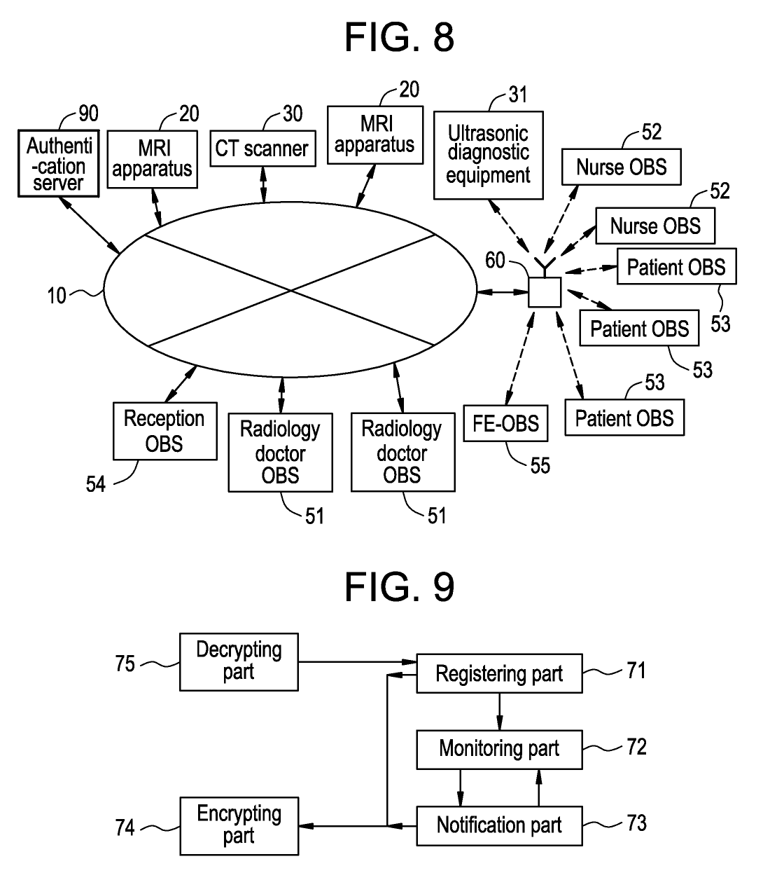

FIG. 8 is a drawing showing an example of a workflow notification system for a medical imaging apparatus as a second embodiment of the invention. An authentication server 90 is connected to the network 10. FIG. 9 is a block diagram showing processing of a dispatch agent in an embodiment of FIG. 8. The registering part 71, monitoring part 72, notification part 73, encrypting part 74, and decrypting part 75 are in common with those of the first embodiment. However, since processing of an authenticating and classifying process in plural medical imaging apparatuses is performed in a concentrated manner in an authenticating server 90, this embodiment is different from the first embodiment, in that the dispatch agent does not include an authenticating and classifying part 70. When an observer terminal transmits an authentication request to the authenticating server 90, the authenticating server 90 determines whether it is an observer terminal to be authenticated, and when it is an observer terminal to be authenticated, further determines a class to which the observer terminal belongs. When it is an observer terminal to be authenticated, the authenticating server 90 transmits an authentication message indicating approval to the observer terminal that requests authentication, and transmits an authentication message indicating approval and a class to which the observer terminal belongs, to a dispatch agent of a medical imaging apparatus requested for authentication. When the observer terminal is not one to be authenticated, the authenticating server 90 transmits an authentication message indicating refusal to the observer terminal that requests authentication. Authentication data and classification data can be collectively managed by the authenticating server 90.

Many widely different embodiments of the invention may be configured without departing from the spirit and the scope of the present invention. It should be understood that the present invention is not limited to the specific embodiments described in the specification, except as defined in the appended claims.

1. A workflow notification system for a medical imaging apparatus comprising: a medical imaging apparatus connected to a network; and plural observer terminals, in which a processor included in the medical imaging apparatus executes plural processing processes, and the plural processing processes generate events tuique to the processing processes, wherein:
the observer terminals transmit a registration request for a specified one of the events to the medical imaging apparatus via the network;
the medical imaging apparatus accepts the registration request transmitted from the observer terminals via the network, monitors the processing processes being executed in the processor, and when detecting the occurrence of the registered event, transmits a notification message to the observer terminals via the network; and
the observer terminals receive the notification message from the medical imaging apparatus.

2. The workflow notification system for a medical imaging apparatus according to claim 1, wherein:
when the event does not occur after transmitting the notification message, the medical imaging apparatus transmits an end message to the observer terminals, when the event further occurs subsequently, the medical imaging apparatus continues to monitor the processing processes being executed in the processor, and when detecting the occurrence of the registered event, the medical imaging apparatus again transmits the notification message to the observer terminals via the network; and
the observer terminals receive at least one of the end message and the notification message from the medical imaging apparatus.

3. The workflow notification system for a medical imaging apparatus according to claim 1, wherein:
when receiving the registration request for the event transmitted from the observer terminals, the medical imaging apparatus determines whether the event is approved for notification in a class to which the observer terminals belong, when the event is approved for notification, the medical imaging apparatus checks the processing processes being executed in the processor to determine whether the event already occurred, when the event already occurs occurred, the medical imaging apparatus transmits a notification message to the observer terminals via the network, and when the event has not occurred, the medical imaging apparatus transmits an acceptance message to the observer terminals; and
the observer terminals receive at least one of the notification message and the acceptance message from the medical imaging apparatus.

4. The workflow notification system for a medical imaging apparatus according to claim 2, wherein:
when receiving the registration request for the event transmitted from the observer terminals, the medical imaging apparatus determines whether the event is approved for notification in a class to which the observer terminals belong, when the event is approved for notification, the medical imaging apparatus checks the processing processes being executed in the processor to determine whether the event already occurred, when the event already occurred, the medical imaging apparatus transmits a notification message to the observer terminals via the network, and when the event has not occurred, the medical imaging apparatus transmits an acceptance message to the observer terminals; and
the observer terminals receive at least one of the notification message and the acceptance message from the medical imaging apparatus.

5. The workflow notification system for a medical imaging apparatus according to claim 1, wherein:
at least two medical imaging apparatuses connected to a network and an authenticating server are included;
the observer terminals transmit an authentication request targeted for a specified medical imaging apparatus to the authenticating server;
when receiving the authentication request, the authenticating server determines whether the observer terminals are ones to be authenticated, and when they are observer terminals to be authenticated, the authenticating server transmits a first authentication approval message to the observer terminals that transmit the authentication request;
when receiving the first authentication approval message, the observer terminals that transmit the authentication request become able to transmit the registration request to the specified medical imaging apparatus;
when the observer terminals that transmit the authentication request are ones to be authenticated, the authentication server further determines a class to which the observer terminals belong, and transmits a second authentication approval message and the class to the specified medical imaging apparatus targeted for the authentication request; and
when receiving the authentication approval message and the class, the specified medical imaging apparatus targeted for the authentication request becomes able to accept the registration request from the observer terminals that transmit the authentication request.

6. The workflow notification system for a medical imaging apparatus according to claim 2, wherein:
at least two medical imaging apparatuses connected to a network and an authenticating server are included;
the observer terminals transmit an authentication request targeted for a specified medical imaging apparatus to the authenticating server;
when receiving the authentication request, the authenticating server determines whether the observer terminals are ones to be authenticated, and when they are observer terminals to be authenticated, the authenticating server transmits a first authentication approval message to the observer terminals that transmit the authentication request;
when receiving the first authentication approval message, the observer terminals that transmit the authentication request become able to transmit the registration request to the specified medical imaging apparatus;
when the observer terminals that transmit the authentication request are ones to be authenticated, the authentication server further determines a class to which the observer terminals belong, and transmits a second authentication approval message and the class to the specified medical imaging apparatus targeted for the authentication request; and
when receiving the authentication approval message and the class, the specified medical imaging apparatus targeted for the authentication request becomes able to accept the registration request from the observer terminals that transmit the authentication request.

7. The workflow notification system for a medical imaging apparatus according to claim 3, wherein:
at least two medical imaging apparatuses connected to a network and an authenticating server are included;
the observer terminals transmit an authentication request targeted for a specified medical imaging apparatus to the authenticating server;
when receiving the authentication request, the authenticating server determines whether the observer terminals are ones to be authenticated, and when they are observer terminals to be authenticated, the authenticating server transmits a first authentication approval message to the observer terminals that transmit the authentication request;
when receiving the first authentication approval message, the observer terminals that transmit the authentication request become able to transmit the registration request to the specified medical imaging apparatus;
when the observer terminals that transmit the authentication request are ones to be authenticated, the authentication server further determines a class to which the observer terminals belong, and transmits a second authentication approval message and the class to the specified medical imaging apparatus targeted for the authentication request; and
when receiving the authentication approval message and the class, the specified medical imaging apparatus targeted for the authentication request becomes able to accept the registration request from the observer terminals that transmit the authentication request.

8. The workflow notification system for a medical imaging apparatus according to claim 1, wherein:
the observer terminals include a reception observer terminal in which the telephone number of a pager is registered; and
on receiving the notification message from the medical imaging apparatus, the reception observer terminal makes a call to the registered telephone number of the pager.

9. A medical imaging apparatus that is connected to a network and includes a processor, the processor executing plural processing processes, the plural processing processes generating events unique to the processing processes, the medical imaging apparatus comprising:
a registering device that accepts a registration request for a specified event from an observer terminal, via the network;
a monitoring device that monitors the processing processes being executed in the processor to detect the occurrence of the registered event; and
a notification device that, when the occurrence of the registered event is detected by the monitoring device, transmits a notification message to the observer terminal via the network.

10. The medical imaging apparatus according to claim 9, wherein:
when the event does not occur after transmitting the notification message, the notification device transmits an end message to the observer terminal, and when the event further occurs subsequently, the notification device proceeds to the monitoring device; and
the monitoring device continues to monitor the processing processes being executed in the processor, and when detecting the occurrence of the registered event, the monitoring device again transmits the notification message to the observer terminal via the network.

11. The medical imaging apparatus according to claim 9, wherein:
on receiving the registration request for the specified event transmitted from the observer terminal, the registering device determines whether the event is approved for notification in a class to which the observer terminal belongs, when the event is approved for notification, the registering device checks the processing processes being executed in the processor to determine whether the event already occurred, when the event already occurs occurred, the registering device transmits a notification message to the observer terminal via the network, and when the event occur has not occurred, the registering device transmits an acceptance message to the observer terminal.

12. The medical imaging apparatus according to claim 9, comprising an authenticating and classifying device that, on receiving an authentication request from the observer terminal, determines whether the observer terminal is one to be authenticated, and when the observer terminal is one to be authenticated, transmits a first authentication approval message to the observer terminal that transmits the authentication request, and determines a class to which the observer terminal that transmits the authentication request belongs.

13. A workflow notification method for a medical imaging apparatus that is connected to a network and includes a processor, the processor executing plural processing processes, the plural processing processes generating events unique to the processing processes, the workflow notification method comprising:
a registering step that accepts a registration request for a specified event from observer terminal, via the network;
a monitoring step that monitors the processing processes being executed in the processor to detect the occurrence of the registered event; and
a notification step that, when the occurrence of the registered event is detected by the monitoring step, transmits a notification message to the observer terminal via the network.

14. The workflow notification method for a medical imaging apparatus according to claim 13, wherein:
when the event does not occur after transmitting the notification message, the notification step transmits an end message to the observer terminal, and when the event further occurs subsequently, the notification step returns to the monitoring step; and
the monitoring step continues to monitor the processing processes being executed in the processor, and when detecting the occurrence of the registered event, the monitoring step again transmits the notification message to the observer terminal via the network.

15. The workflow notification method for a medical imaging apparatus according to claim 13, wherein, on receiving the registration request for the specified event transmitted from the observer terminal, the registering step determines whether the event is approved for notification in a class to which the observer terminal belongs, when the event is approved for notification, the registering step checks the processing processes being executed in the processor to determine whether the event already occurs occurred, when the event already occurred, the registering step transmits a notification message to the observer terminal via the network, and when the event does not occur has not occurred, the registering step transmits an acceptance message to the observer terminal.

16. The workflow notification method for a medical imaging apparatus according to claim 13, the method further including, prior to the registration step:
an authenticating and classifying step that, on receiving an authentication request from the observer terminal, determines whether the observer terminal is one to be authenticated, and when the observer terminal is one to be authenticated, transmits a first authentication approval message to the observer terminal that transmits the authentication request, and determines a class to which the observer terminal that transmits the authentication request belongs.

17. A workflow notification program for a medical imaging apparatus that is executed in a processor, the processor being included in a medical imaging apparatus connected to a network and executing plural processing processes, the plural processing processes generating events unique to the processing processes, the workflow notification program instructing the processor to execute:
a registering step that accepts a registration request for a specified event from an observer terminal, via the network;
a monitoring step that monitors the processing processes being executed in the processor to detect the occurrence of the registered event; and
a notification step that, when the occurrence of the registered event is detected by the monitoring step, transmits a notification message to the observer terminal via the network.

18. The workflow notification program for a medical imaging apparatus according to claim 17, wherein:
when the event does not occur after transmitting the notification message, the notification step transmits an end message to the observer terminal, and when the event further occurs subsequently, the notification step returns to the monitoring step; and
the monitoring step continues to monitor the processing processes being executed in the processor, and when detecting the occurrence of the registered event, the monitoring step again transmits the notification message to the observer terminal via the network.

19. The workflow notification program for a medical imaging apparatus according to claim 17, wherein on receiving the registration request for the specified event transmitted from the observer terminal, the registering step determines whether the event is approved for notification in a class to which the observer terminal belongs, when the event is approved for notification, the registering step checks the processing processes being executed in the processor to determine whether the event already occurred, when the event already occurred, the registering step transmits a notification message to the observer terminal via the network, when the event has not occurred, the registering step transmits an acceptance message to the observer terminal.

20. The workflow notification program for a medical imaging apparatus according to claim 17, instructing the processor to execute, prior to the registering step, an authenticating and classifying step that, on receiving an authentication request from the observer terminal, determines whether the observer terminal is one to be authenticated, when the observer terminal is one to be authenticated, transmits a first authentication approval message to the observer terminal that transmits the authentication request, and determines a class to which the observer terminal that transmits the authentication request belongs.
